(19) United States
(12) Patent Application Publication
(10) Pub. No.: US 2013/0101014 A1
(43) Pub. Date: Apr. 25, 2013

(54) Layered Screen Video Encoding

(71) Applicants: Jingjing Fu, Beijing (CN); Shiqi Wang, Beijing (CN); Yan Lu, Beijing (CN); Shipeng Li, Beijing (CN)

(72) Inventors: Jingjing Fu, Beijing (CN); Shiqi Wang, Beijing (CN); Yan Lu, Beijing (CN); Shipeng Li, Beijing (CN)

(73) Assignee: MICROSOFT CORPORATION, Redmond, WA (US)

(21) Appl. No.: 13/281,378

(22) Filed: Oct. 25, 2011

(51) Int. Cl. H04N 7/26

(52) U.S. Cl. 375/240.1; 375/E07.077

(57) ABSTRACT

A computing device is described herein that is configured to encode natural video content in accordance with a first encoding scheme and screen content in accordance with a second encoding scheme. The computing device is configured to distinguish between the natural video content of a video frame and the screen content of the video frame based at least in part on temporal correlations between the video frame and one or more neighboring video frames and on content analysis of the video frame.

### BACKGROUND

Remote processing applications enable users to interact with their local display screen while receiving video which is generated remotely and transmitted to the client side after compression. The efficiency of the compression scheme used in providing the video directly determines the performance of the remote display. In the most of the remote scenarios, such as remote web browsing, video watching, etc., the video is a mixture of natural video content and computer-generated screen content. In each frame of the video, natural video content and text and graphics constituting the screen content may occur simultaneously. While traditional transform-based video encoding standards are suitable for compressing the natural video content, these standards do not perform as well when compressing the screen content.

A number of encoding schemes for separately encoding graphic and textual content in images, such as web pages, are known. Often, these schemes separate blocks of the image into multiple layers and separately encode those layers. These image-based compression schemes, however, do not work well for video content. They fail to account for temporal correlations between frames of the video content and thus provide less-than-optimal encoding.

### SUMMARY

This disclosure describes a computing device that is configured to distinguish between natural video content of a video frame and screen content of the video frame based at least in part on temporal correlations between the video frame and one or more neighboring video frames and on content analysis of the video frame. The computing device is further configured to encode the natural video content in accordance with a first encoding scheme and the screen content in accordance with a second encoding scheme. The encoded natural video content and encoded screen content are then provided as subframes to a decoding device that decodes the subframes based on the different encoding schemes used to encode the subframes and merges the decoded subframes into an output video frame.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 illustrates an overview of data and modules involved in distinguishing natural video content of a video frame from screen content of that frame and in encoding the natural video content and the screen content in accordance with different encoding schemes, in accordance with various embodiments.

FIGS. 2A-2B illustrate example histograms utilized by an object-level analysis module in defining one or more natural video regions in a video frame, in accordance with various embodiments.

FIG. 3 illustrates an example environment including an encoding device and a decoding device, in accordance with various embodiments.

FIG. 4 is a flowchart showing an illustrative process for distinguishing natural video content of a video frame from screen content of that frame and encoding the natural video content and the screen content in accordance with different encoding schemes, in accordance with various embodiments.

FIG. 5 is a flowchart showing an illustrative process for receiving encoded natural video content subframes and encoded screen content subframes and decoding the subframes based on the different encoding schemes used to encode the subframes, in accordance with various embodiments.

FIG. 6 is a block diagram of an example computer system architecture of a computing device that is capable of serving as an encoding device, a decoding device, or both, in accordance with various embodiments.

### DETAILED DESCRIPTION

### Overview

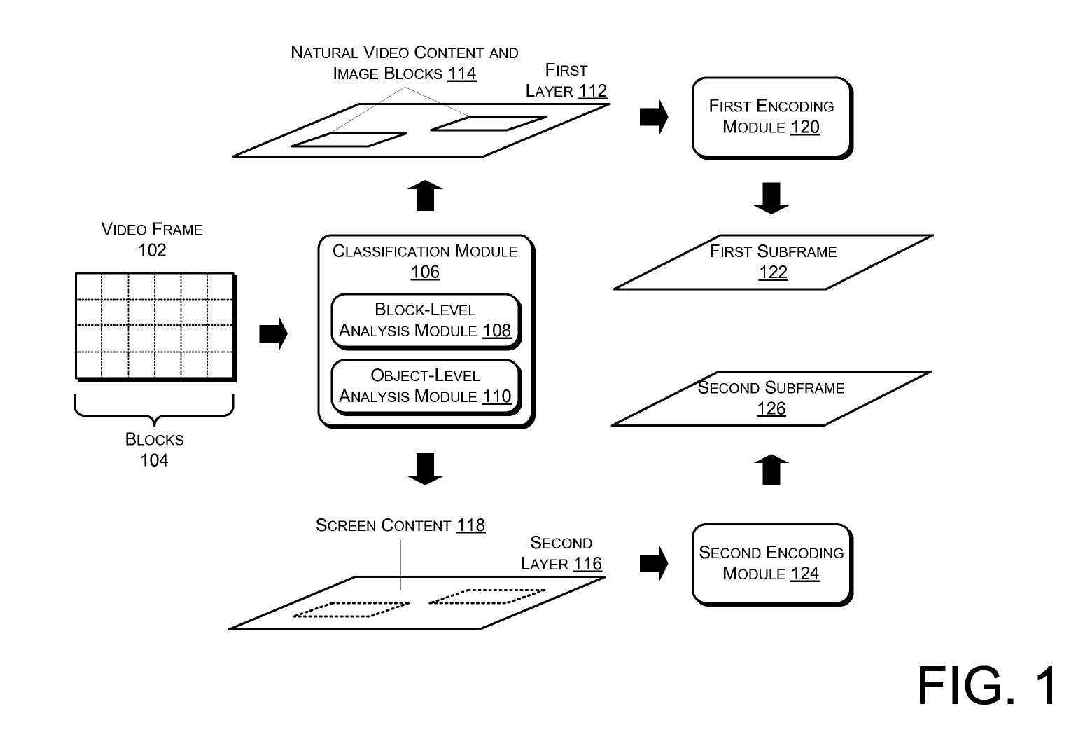

FIG. 1 illustrates an example environment, in accordance with various embodiments. As shown in FIG. 1, a video frame 102 constituted by a plurality of blocks 104 is processed by a classification module 106. The classification module 106 performs a block-level analysis with its block-level analysis module 108 and an object-level analysis with its object-level analysis module 110. Based on these analyses, the classification module 106 distinguished the video frame 102 into a first layer 112 that included natural video content and image blocks 114 and a second layer 116 that includes screen content 118. The first layer 112 is encoded by a first encoding module 120 to generate first subframes 122, and the second layer 116 is encoded by a second encoding module 124 to generate second subframes 126.

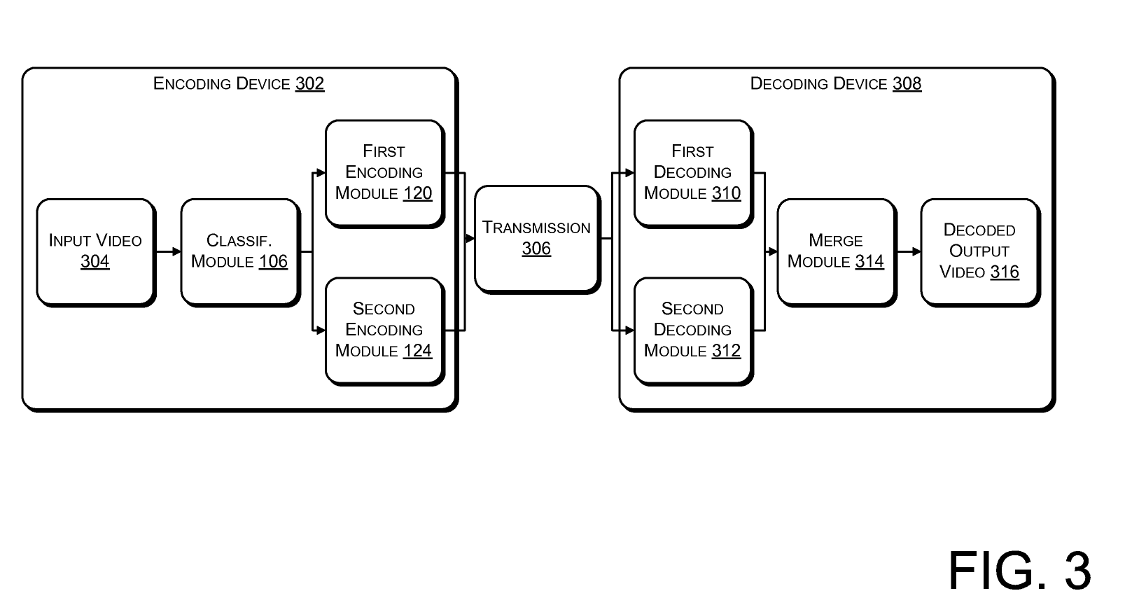

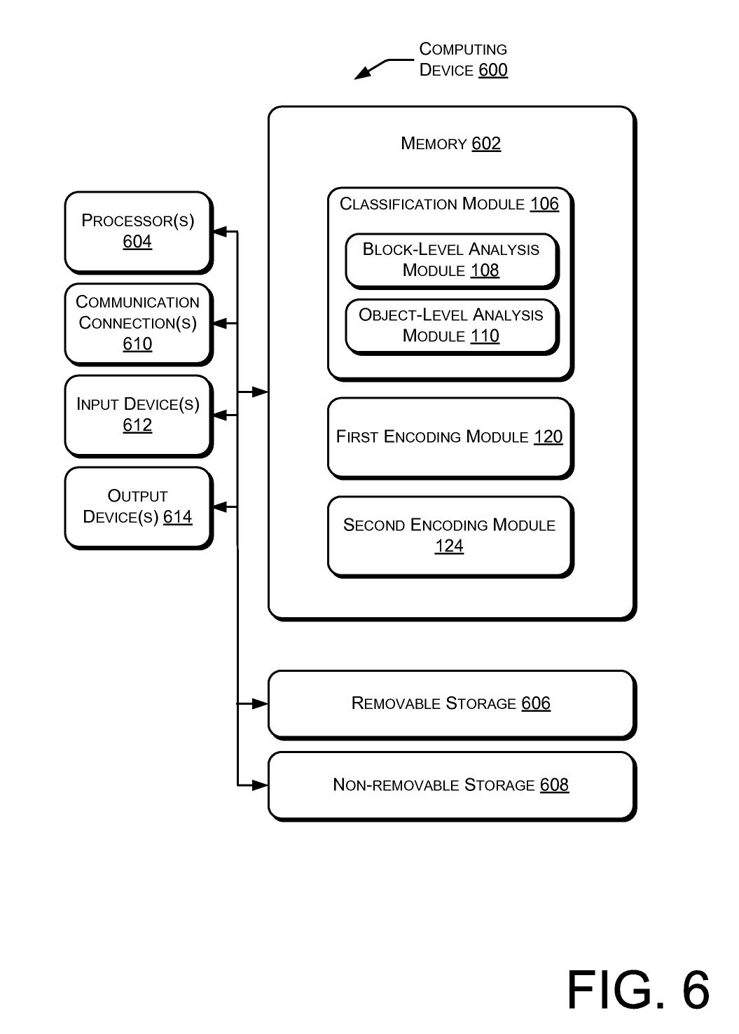

Example devices capable of including the modules and data of FIG. 1 and of performing the operations described with reference to FIG. 1 are illustrated in FIGS. 3 and 6 and described further herein with reference to those figures.

In various embodiments, video frame 102 is one of a plurality of video frames constituting a video stream. The video stream may be associated with any sort of content, such as a movie, a television program, a webpage, or any sort of content capable of being streamed as video. The video frame 102 may include both natural video content and screen content. Natural video content includes videos and images, things such as movies, television, etc. Screen content is computer-generated and includes graphics and text. Screen content often differs from natural video content in that screen content includes little of the natural texture typically present in natural video content. As can further be seen in FIG. 1, video frame 102 is constituted by block 104. Blocks 104 may be macro-blocks of the video frame 102 or may be parts of the image of any of a number of sizes and/or shapes. In one embodiment, each block has a size of sixteen pixels by sixteen pixels.

In some embodiments, each video frame 102 is received and processed by the classification module 106 to separate the video frame 102 into a first layer 112 and a second layer 116 based on temporal correlations between video frames 102 and content analysis of each video frame 102. The resulting first layer 112 includes the natural video content and image blocks 114 that are optimally encoded by the first encoding scheme utilized by the first encoding module 120. The resulting second layer 116 includes the screen content 118 that is optimally encoded by the second encoding scheme utilized by the second encoding module 124.

In various embodiments, the block-level analysis module 108 classifies each of the blocks 104 constituting the video frame 102 as a skip block, a text block, a consistent image block, and an inconsistent image block. In classifying the blocks 104, the block-level analysis module 108 first determines which of the blocks 104 are skip blocks. Skip blocks are blocks that have not changed since a previous frame of the video. In one embodiment, the block-level analysis module 108 computes a sum of absolute differences (SAD) between each block 104 and its corresponding block in the predecessor video frame. If the SAD of the blocks is below a threshold, the block 104 is considered to be “unchanged” and is classified by the block-level analysis module 108 as a skip block.

The block-level analysis module 108 then classifies the remaining blocks 104 as image blocks or text blocks based on one or more of pixel base-colors, pixel gradients, or block-boundary smoothness. Pixel base-colors, pixel gradients, or block-boundary smoothness tend to be different for image blocks and text blocks and are thus taken as an indication of a block's appropriate type. An example technique for determining the pixel base-colors, pixel gradients, or block-boundary smoothness of blocks is described in [MS1-5187US].

In some embodiments, after classifying one or more of the blocks 104 as image blocks, the block-level analysis module 108 further classifies those image blocks as consistent image blocks or inconsistent image blocks. To determine whether a block 104 is a consistent image block, the block-level analysis module 108 compares the block types across neighboring frames for a given block location. For example, if a block 104 in video frame 102 is classified as an image block and its corresponding block in a previous video frame is also classified as an image block, then the block-level analysis module 108 classifies that block 104 as a consistent image block. The block-level analysis module 108 than classifies other image blocks as inconsistent image blocks.

In various embodiments, after the block-level analysis is performed, the object-level analysis module 110 is invoked and the classifications of the blocks 104 are provided to the object-level analysis module 110 as inputs. The object-level analysis module 110 then assigns a weight to each block 104. For example, the weight assigned each block 104 may be defined as:

$$w ( i , j ) = \{ \begin{matrix}3 , & Consistent image block \\ 2 , & Inconsistent image block \\ 0 , & Other blocks\end{matrix}$$

where w(i, j) is the weight for the (i, j)th block.

The object-level analysis module 110 then utilizes the weights to measure the block level activity in the horizontal and vertical directions for each block 104. The block level activity is measured by accumulating the weights w(i, j) in the horizontal and vertical directions. The formulas for accumulating the weights may be specified as follows:

$${w}_{Hor} ( i ) = {\sum }_{j = 1}^{H} {w}_{i , j}$$

$${w}_{Ver} ( j ) = {\sum }_{i = 1}^{W} {w}_{i , j}$$

where H and W indicate the height and width of the video frame 102.

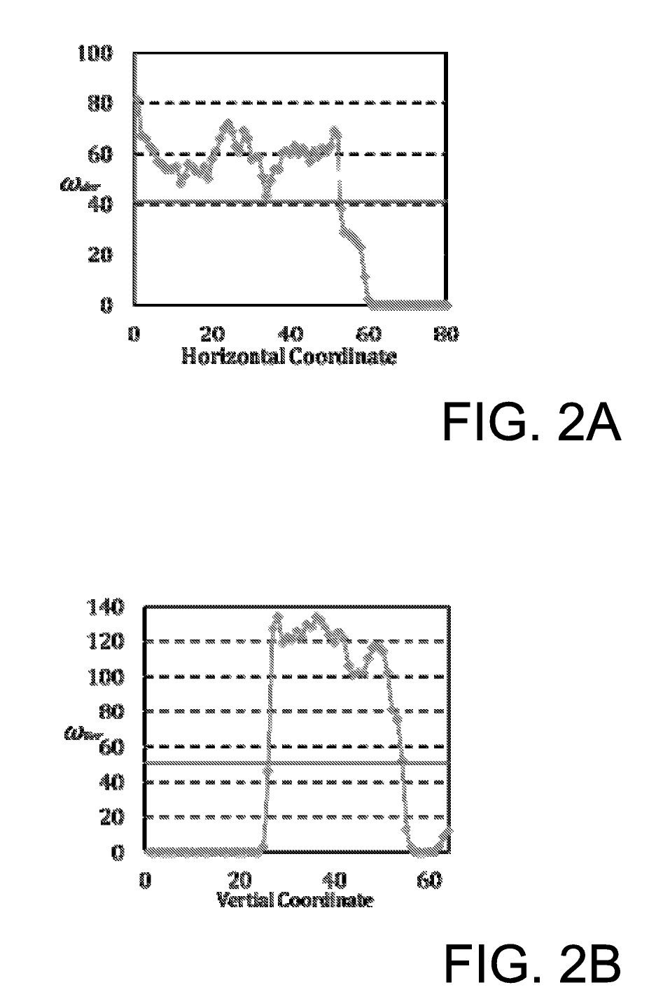

In some embodiments, the object-level analysis module 110 then generates histograms for the horizontal and vertical directions. Each histogram includes a weight axis and a block coordinate axis. The histogram for the horizontal direction includes an axis of w_{Hor}(i) values and an axis corresponding to the i coordinates. FIG. 2A illustrates an example of such a histogram for the horizontal direction. The histogram for the vertical direction includes an axis of w_{Ver}(j) values and an axis corresponding to the j coordinates. FIG. 2B illustrates an example of such a histogram for the vertical direction.

The object-level analysis module 110 then calculates the average bin value for each histogram and determines which blocks 104 have both their horizontal and vertical coordinates corresponding to weight values that are above the average bin values for the histograms. Upon making those calculations and determinations, the object-level analysis module 110 classifies blocks 104 that have weight values for both their horizontal and vertical coordinates above the average bin values as natural video content blocks.

After performing the object-level analysis, each block 104 of the video frame has a block-level classification as a skip block, text block, consistent image block, or inconsistent image block. Some of the blocks 104 may also may an object-level classification as natural video content. Using these classifications, the classification module 106 associates the blocks classified as image blocks, natural video content, or both with the first layer 112. The classification module 106 may also associate blocks classified as skip blocks that are neighbors of natural video content blocks and/or image blocks with the first layer 112. For example, all skip blocks that are surrounded by natural video content blocks may be associated with the first layer 112. The classification module 106 then associates any blocks that have not been associated with the first layer 112 with the second layer 116, these remaining blocks constituting the screen content 118.

In some embodiments, the computing device including the modules and data of FIG. 1 engages in negotiation regarding supported encoding schemes with a device that is to receive and decode the first subframes 122 and second subframes 126. If that decoding device only supports the first encoding scheme, the classification module 106 may be notified and may classify all parts of the video frame 102 as being part of the first layer 112. If the decoding device only supports the second encoding scheme, the classification module 106 may be notified and may classify all parts of the video frame 102 as being part of the second layer 116.

In various embodiments, as mentioned above, the first layer 112 is encoded by the first encoding module 120. The first encoding module 120 encodes the first layer 112 using a natural video encoding scheme such as the MPEG2 or H.264/AVC compression algorithm to generate the encoded first subframe 122. The first subframe 122 has the same dimensions as the video frame 102 and includes the natural video content and image blocks 114 as well as vacant blocks to represent the screen content 118. The first encoding module 120 encodes the vacant blocks by intra-frame encoding those vacant blocks with average pixel values and inter-frame encoding them by forcing the vacant blocks to be SKIP mode. The average pixel values for a vacant block are the average pixel values of Y, Cb and Cr components of the corresponding block in the screen content 118.

As also mentioned above, in some embodiments, the second layer 116 is encoded by the second encoding module 124. The second encoding module 124 encodes the second layer 116 using an encoding scheme that quantitizes pixels of the screen content 118 to base-colors and entropy encodes indices of the base-colors. Such an encoding scheme is described in U.S. Pat. No. 7,903,873, entitled “Textual Image Coding,” which issued on Mar. 8, 2011. In one embodiment, in addition to encoding the screen content 118, the second encoding module 124 encodes a mask with the second layer 116 to enable the receiving, decoding device to merge the second subframe 126 generated by the second encoding module 124 with the first subframe 122.

In various embodiments, the first subframe 122 and second subframe 126 are video frames of the same dimensions as the video frame 102. However, each of the subframes 122 and 126 includes only a part of the content/blocks of the video frame 102. The additional parts of each of the subframes 122 and 126 constitute vacant blocks, such as the vacant blocks described above.

### Example Environment

FIG. 3 illustrates an example environment including an encoding device and a decoding device, in accordance with various embodiments. As shown in FIG. 3, an encoding device 302 encodes an input video 304 by utilizing a classification module 106 to distinguish between natural video content and screen content. The natural video content is encoded by a first encoding module 120 and the screen content is encoded by a second encoding module 124. The outputs of the first encoding module 120 and second encoding module 124 are subframes, such as first subframes 122 and second subframes 126, and are provided by the encoding device 302 through transmission 306 to a decoding device 308. The subframes are decoded by a first decoding module 310 and a second decoding module 312, and the decoded subframes are provided to a merge module 314 of the decoding device 308 for merging into a decoded output video 316.

In various embodiments, each of the encoding device 302 and the decoding device 308 may be any sort of computing device or computing devices. For example, the encoding device 302 or the decoding device 308 may be or include a personal computer (PC), a laptop computer, a server or server farm, a mainframe, a tablet computer, a work station, a telecommunication device, a personal digital assistant (PDA), a media player, a media center device, a personal video recorder (PVR), a television, or any other sort of device or devices. In one implementation, the encoding device 302 or the decoding device 308 represents a plurality of computing devices working in communication, such as a cloud computing network of nodes. In some implementations, the encoding device 302 and the decoding device 308 represent virtual machines implemented on one or more computing devices. An example encoding device 302/decoding device 308 is illustrated in FIG. 6 and is described below in greater detail with reference to that figure.

In some implementations, transmission 306 represents a network or networks that connect the encoding device 302 and the decoding device 308. The network or networks may be any one or more networks, such as wide area networks (WANs), local area networks (LANs), or the Internet. Also, the network or networks may be public, private, or include both public and private networks. Further, the network or networks may be wired, wireless, or include both wired and wireless networks. The network or networks may utilize any one or more protocols for communication, such as the Transmission Control Protocol/Internet Protocol (TCP/IP), other packet based protocols, or other protocols. Additionally, the network or networks may comprise any number of intermediary devices, such as routers, base stations, access points, firewalls, or gateway devices. In other embodiments, the transmission 306 represents a physical connection, such as a Universal Serial Bus (USB) connection between the encoding device 302 and the decoding device 308. In yet other embodiments, where the encoding device 302 and the decoding device 308 are virtual machines, the transmission 306 may be a virtual bus.

In various embodiments, the input video 304 comprises a plurality of video frames, such as video frame 102. These video frames are separated into first and second layers by the classification module 106 and encoded by the first encoding module 120 and second encoding module 124 to generate encoded first subframes 122 and encoded second subframes 126. These encoded subframes 122 and 126 are transmitted as video streams via the transmission 306 to the decoding device 308. The classification module 106, first encoding module 120, and second encoding module 124 are described above in greater detail with reference to FIG. 1.

In various embodiments, the first decoding module 310 receives the video stream of the first subframes 122 and decodes the subframes 122 based on the first encoding scheme. As mentioned above, the first encoding scheme is a natural video encoding scheme such as the MPEG2 or H.264/AVC compression algorithm. Such encoding schemes have corresponding decoding algorithms that are utilizes by the first decoding module 310 to recover the first layer 112, which includes natural video content blocks and image blocks, from the encoded first subframes 122.

The second decoding module 312 receives the video stream of the second subframes 126 and decodes the subframes 126 based on the second encoding scheme. As mentioned above, the second encoding scheme quantitizes pixels of the screen content 118 to base-colors and entropy encodes indices of the base-colors. This encoding scheme has corresponding decoding algorithms. Examples of such decoding algorithms are described in U.S. Pat. No. 7,903,873, entitled “Textual Image Coding,” which issued on Mar. 8, 2011. The second decoding module 312 utilizes the decoding algorithms to recover the second layer 116, which includes screen content blocks 118, from the second subframes. As also mentioned above, the second subframes 126 may include mask information to be used for performing subframe merges. The decoding algorithms may also retrieve this mask information from the subframes.

In some embodiments, the first layer 112 and second layer 116 are then provided to the merge module 314 by the first decoding module 310 and second decoding module 312, respectively. In embodiments in which mask information was provided with the subframes, the mask information is also provided to the merge module 314 and used by the merge module 314 to combine the first layer 112 and second layer 116 into output video frames of the decoded output video 316. In other embodiments, the merge module 314 may utilize one or more image processing techniques to identify and remove padding blocks in the first layer 112 and second layer 116 and to combine the results.

### Example Operations

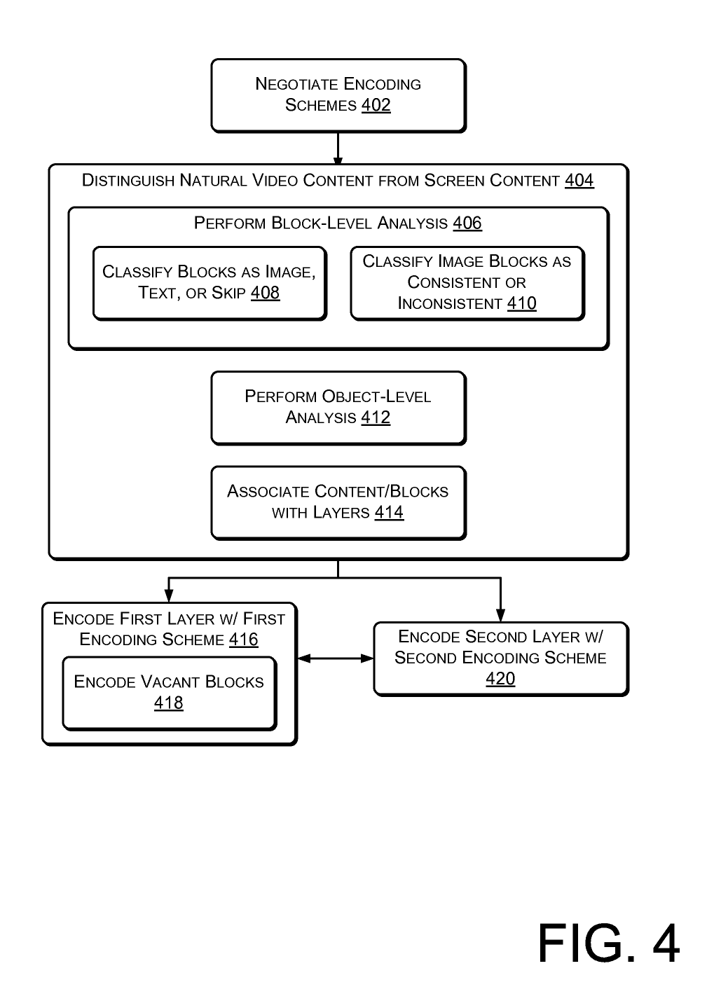

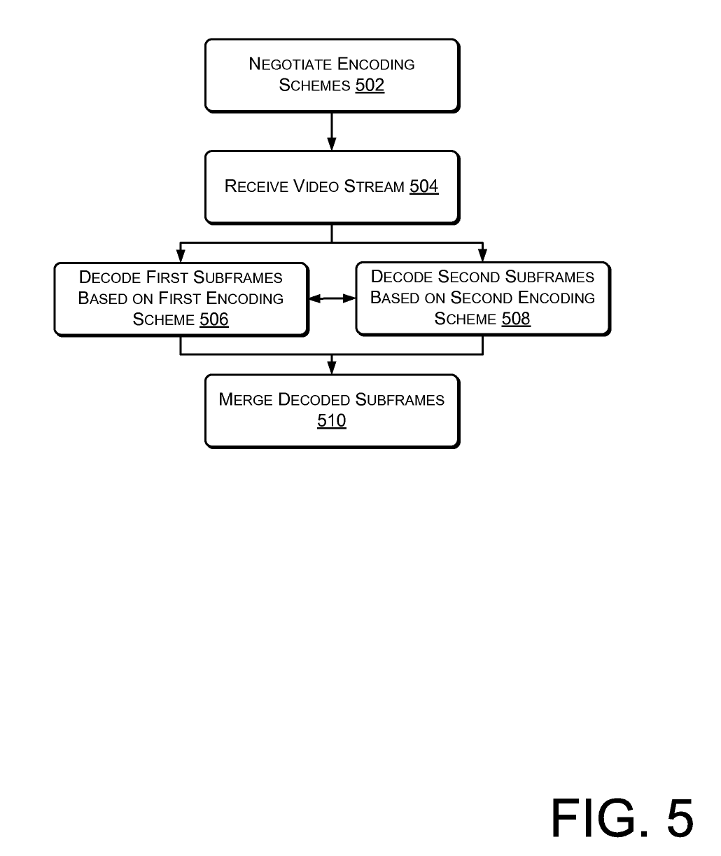

FIGS. 4 and 5 are flowcharts showing operations of example processes. The operations of the processes are illustrated in individual blocks and summarized with reference to those blocks. These processes are illustrated as logical flow graphs, each operation of which may represent a set of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 4 is a flowchart showing an illustrative process for distinguishing natural video content of a video frame from screen content of that frame and encoding the natural video content and the screen content in accordance with different encoding schemes, in accordance with various embodiments. As illustrated at block 402, a computing device may negotiate encoding schemes with a communication partner prior to encoding a video stream.

At block 404, once the devices have reached agreement on supported encoding schemes, the computing device may distinguish natural video content in video frames of the video stream from screen content of the video frames based at least in part on temporal correlations between each video frame and its one or more neighboring video frames and on content analysis of each video frame. At block 406, the distinguishing may involve performing a block-level analysis of each frame. At block 408, the block-level analysis includes identifying blocks of the video frame as image blocks, skip blocks, or text blocks. Classifying a block of the plurality of blocks as an image block or a text block may be based on one or more of pixel base-colors, pixel gradients, or block-boundary smoothness. Also, a block may be classified as a skip block in response to determining differences between that block and a corresponding block of one of the neighboring video frames do not exceed a threshold. At block 410, the block-level analysis further involves classifying image blocks as consistent image blocks or inconsistent image blocks. Classifying each image block as a consistent image block or an inconsistent image block may involve comparing each image block to a corresponding block of one of the neighboring video frames and determining whether differences between each pair of compared blocks exceed a threshold.

At block 412, the distinguishing further includes performing an object-level analysis, the object-level analysis including determining horizontal and vertical boundaries of the natural video content by measuring block level activity for each block in horizontal and vertical directions. Measuring the block level activity may include assigning a weight to each block based on whether the block is a consistent image block, an inconsistent image block, or another type of block, and summing the weights in horizontal and vertical directions. Upon measuring the block level activities, the computing device performing the object-level analysis may associate the block level activity of each block with a histogram bin of a histogram, average bin values of the histogram, and classify as natural video content each block with a measured block activity level exceeding the average bin value.

Further, at block 414, the distinguishing includes associating the natural video content, image blocks, and skip blocks neighboring the natural video content or the image blocks with a first layer and associating remaining blocks of the video frame with a second layer.

At block 416, the computing device then encodes the first layer in accordance with a first encoding scheme. The first encoding scheme may be a MPEG2 or H.264/AVC compression algorithm. At block 418, this encoding may involve intra-frame encoding vacant blocks with average pixel values and inter-frame encoding the vacant blocks with a skip mode.

At block 420, the computing device then encodes the second layer in accordance with a second encoding scheme. The second encoding scheme may quantitize pixels of the screen content to base-colors and entropy encode indices of the base-colors.

FIG. 5 is a flowchart showing an illustrative process for receiving encoded natural video content subframes and encoded screen content subframes and decoding the subframes based on the different encoding schemes used to encode the subframes, in accordance with various embodiments. As illustrated at block 502, a computing device may negotiate encoding schemes with a communication partner prior to receiving an encoded video stream.

At block 504, the computing device may receive the encoded video stream as subframes of natural video content encoded in accordance with a first encoding scheme and subframes of screen content encoded in accordance with a second encoding scheme.

At block 506, the computing device may decode the subframes of natural video content based on the first encoding scheme and, at block 508, decode the subframes of screen content based on the second encoding scheme. The first encoding scheme may be a MPEG2 or H.264/AVC compression algorithm and the second encoding scheme may quantitize pixels of the screen content to base-colors and entropy encode indices of the base-colors.

At block 510, the computing device may merge the subframes based on mask information decoded from the subframes of screen content.

### Example System Architecture

FIG. 6 is a block diagram of an example computer system architecture of a computing device 600 that is capable of serving as an encoding device 302, a decoding device 308, or both. As shown, the computing device 600 may comprise at least a memory 602 (including a cache memory) and one or more processing units (or processor(s)) 604. The processor(s) 604 may be implemented as appropriate in hardware, software, firmware, or combinations thereof. Software or firmware implementations of the processor(s) 604 may include computer-executable or machine-executable instructions written in any suitable programming language to perform the various functions described. Processor(s) 604 may also or alternatively include one or more graphic processing units (GPUs).

Memory 602 may store program instructions that are loadable and executable on the processor(s) 604, as well as data generated during the execution of these programs. Depending on the configuration and type of computing device, memory 602 may be volatile (such as random access memory (RAM)) and/or non-volatile (such as read-only memory (ROM), flash memory, etc.). The computing device or server may also include additional removable storage 606 and/or non-removable storage 608 including, but not limited to, magnetic storage, optical disks, and/or tape storage. The disk drives and their associated computer-readable media may provide non-volatile storage of computer readable instructions, data structures, program modules, and other data for the computing devices. In some implementations, the memory 602 may include multiple different types of memory, such as static random access memory (SRAM), dynamic random access memory (DRAM), or ROM.

Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, erasable programmable read-only memory (EEPROM), flash memory or other memory technology, compact disc read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The computing device 600 may also contain communications connection(s) 610 that allow the computing device 600 to communicate with a stored database, another computing device or server, user terminals, and/or other devices on a network. The computing device 600 may also include input device(s) 612, such as a keyboard, mouse, pen, voice input device, touch input device, etc., and output device(s) 614, such as a display, speakers, printer, etc.

Turning to the contents of the memory 602 in more detail, the memory 602 may include the classification module 106, the block-level analysis module 108, the object-level analysis module 110, the first encoding module 120, and the second encoding module 124, which may each represent any one or more modules, applications, processes, threads, or functions. In other embodiments, the memory 602 may also or instead include the first decoding module 310, the second decoding module 312, and the merge module 314. These modules are described above in greater detail. The memory 602 may further store data associated with and used by the modules, as well as modules for performing other operations.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

We claim:

1. A computer-implemented method comprising:
distinguishing between natural video content of a video frame and screen content of the video frame based at least in part on temporal correlations between the video frame and one or more neighboring video frames and on content analysis of the video frame; and
encoding the natural video content in accordance with a first encoding scheme and the screen content in accordance with a second encoding scheme.

2. The method of claim 1, wherein the distinguishing comprises performing at least one of a block level analysis and an object level analysis.

3. The method of claim 2, wherein the block level analysis includes classifying each of a plurality of blocks constituting the video frame as an image block, a skip block, or a text block.

4. The method of claim 3, wherein the classifying includes classifying a block of the plurality of blocks as an image block or a text block based on one or more of pixel base-colors, pixel gradients, or block-boundary smoothness.

5. The method of claim 3, wherein the classifying includes classifying a block of the plurality of blocks as a skip block in response to determining differences between that block and a corresponding block of one of the neighboring video frames do not exceed a threshold.

6. The method of claim 3, wherein the block level analysis further comprises classifying each image block as a consistent image block or an inconsistent image block.

7. The method of claim 6, wherein classifying each image block as a consistent image block or an inconsistent image block comprises comparing each image block to a corresponding block of one of the neighboring video frames and determining whether differences between each pair of compared blocks exceed a threshold.

8. The method of claim 7, wherein the object level analysis comprises determining horizontal and vertical boundaries of the natural video content by measuring block level activity for each block in horizontal and vertical directions.

9. The method of claim 1, wherein the distinguishing comprises associating the natural video content, image blocks, and skip blocks neighboring the natural video content or the image blocks with a first layer and associating remaining blocks of the video frame with a second layer.

10. The method of claim 9, wherein the encoding comprises encoding the first layer in accordance with the first encoding scheme and encoding the second layer in accordance with the second encoding scheme.

11. The method of claim 1, wherein the first encoding scheme comprises an MPEG2 or H.264/AVC compression algorithm.

12. The method of claim 11, wherein encoding the natural video content in accordance with the first encoding scheme comprises intra-frame encoding vacant blocks with average pixel values and inter-frame encoding the vacant blocks with a skip mode.

13. The method of claim 1, wherein the second encoding scheme quantitizes pixels of the screen content to base-colors and entropy encodes indices of the base-colors.

14. A system comprising:
one or more processors; and
a plurality of executable components configured to be operated by the processor, the executable components including:
a block level analysis module configured to classify blocks constituting a video frame as image blocks, skip blocks, or text blocks based on a content analysis of the video frame and to classify image blocks as consistent image blocks or inconsistent image blocks based on temporal correlations between the video frame and one or more neighboring video frames;
an object level analysis module configured to distinguish between natural video content and screen content based on the block classifications of the blocks of the video frame and measures of block-level activity of each block;
a natural video encoder configured to encode the natural video content and image blocks in accordance with a first encoding scheme; and
a screen content encoder to encode screen content in accordance with a second encoding scheme.

15. The system of claim 14, wherein the object level analysis module is further configured to measure the block level activity by assigning a weight to each block based on whether the block is a consistent image block, an inconsistent image block, or another type of block, and summing the weights in horizontal and vertical directions.

16. The system of claim 15, wherein the object level analysis module is further configured to associate the block level activity of each block with a histogram bin of a histogram, average bin values of the histogram, and classify as natural video content each block with a measured block activity level exceeding the average bin value.

17. One or more computer storage media comprising computer-executable instructions stored thereon and configured to program a computing device to perform operations including:
receiving a video stream comprising subframes of natural video content encoded in accordance with a first encoding scheme and subframes of screen content encoded in accordance with a second encoding scheme;
decoding the subframes of natural video content based on the first encoding scheme and the subframes of screen content based on the second encoding scheme; and
merging the subframes based on mask information decoded from the subframes of screen content.

18. The one or more computer storage media of claim 17, wherein the operations further include negotiating supported encoding schemes with an encoding device providing the video stream to affect encoding of the video stream.

19. The one or more computer storage media of claim 17, wherein the first encoding scheme comprises an MPEG2 or H.264/AVC compression algorithm.

20. The one or more computer storage media of claim 17, wherein the second encoding scheme quantitizes pixels of the screen content to base-colors and entropy encodes indices of the base-colors.
